(19) United States
(12) Patent Application Publication
(10) Pub. No.: US 2026/0238657 A1
(43) Pub. Date: Aug. 13, 2026

(54) ARTIFICIAL INTELLIGENCE AND MACHINE LEARNING DEFENSE CONTROLLER FOR PROMPT AND ANSWER INSPECTION

(71) Applicant: Cisco Technology, Inc., San Jose, CA (US)

(72) Inventors: Arjun Sambamoorthy, San Jose, CA (US); Chetan Anand, Mountain View, CA (US); Anand Raghavan, Santa Clara, CA (US); Dhananjay Sampath, Sunnyvale, CA (US); Abhiram Parvathareddy, Redwood City, CA (US); Sanjay Singh, Pimpri-Chinchwad (IN)

(21) Appl. No.: 19/233,959

(22) Filed: Jun. 10, 2025

(30) Foreign Application Priority Data
Feb. 13, 2025 (IN) 202541012296

(51) Int. Cl. H04L 9/40

(52) U.S. Cl. CPC H04L 63/1416; H04L 63/1425; H04L 63/1433

(57) ABSTRACT

Disclosed are systems, apparatuses, processes, and computer-readable media for inspecting ML payload. For example, a system comprises a runtime inspection engine configured to determine whether to allow a request or response to or from a first machine learning model based on an inspection of a payload, wherein the runtime inspection engine is configured to analyze a natural language prompt in the request to determine whether the request corresponds to a permitted scope associated with an application generating the request, wherein the runtime inspection engine is configured to analyze an answer in the response in conjunction with the prompt and determine whether the response corresponds to the permitted scope; and a discovery engine configured to identify ML assets and applications implementing ML models, wherein the discover engine is further configured to detect runtime usage of a workload that uses a second ML model that is unsanctioned.

### CROSS REFERENCE TO RELATED APPLICATIONS

This application claims priority to Indian Patent Application No. 202541012296, filed February 13, 2025, entitled “ARTIFICIAL INTELLIGENCE AND MACHINE LEARNING DEFENSE CONTROLLER FOR PROMPT AND ANSWER INSPECTION” which is incorporated by reference herein in its entirety.

### TECHNICAL FIELD

The disclosure relates generally to network security, and more specifically an artificial intelligence and machine learning defense controller for prompt and answer inspection

### BACKGROUND

Network security is a critical aspect of modern digital infrastructure, ensuring that data, applications, and systems remain protected from unauthorized access, cyber threats, and malicious activities. Traditionally, network security relied on perimeter-based defenses like firewalls and intrusion detection systems. However, as networks evolved with cloud computing, microservices, and zero-trust architectures, security approaches shifted towards inline threat detection, where malicious activities are identified and mitigated in real-time as traffic flows through the network. Deep Packet Inspection (DPI) and Intrusion Prevention Systems (IPS) are commonly used techniques to identify malware, command-and-control traffic, and policy violations. Additionally, cloud security platforms provide inline threat intelligence, leveraging global threat databases to detect and prevent cyberattacks dynamically. The ability to identify threats inline allows organizations to respond in real-time, enforce security policies proactively, and prevent data breaches before they escalate into significant incidents.

Another important aspect is data loss prevention (DLP) to prevent unauthorized access, transfer, or leakage of sensitive information. Organizations use DLP solutions to detect, monitor, and control data movement across networks, endpoints, and cloud environments, ensuring compliance with regulations like General Data Protection Regulation (GDPR), Health Insurance Portability and Accountability Act (HIPAA), and California Consumer Privacy Act (CCPA). DLP also addresses data exfiltration and attempt to steal sensitive data by bypassing security controls. Data exfiltration can occur through various channels, including phishing attacks, malware, misconfigured cloud storage, external storage devices, encrypted tunnels, or covert domain name server (DNS) traffic.

### BRIEF DESCRIPTION OF THE DRAWINGS

Illustrative embodiments of the present application are described in detail below with reference to the following drawing figures:

FIG. 1 is a conceptual block diagram of an artificial intelligence (AI) defense controller system in accordance with some aspects of the disclosure;

FIG. 2 is a conceptual diagram of an inspection path of the AI defense controller system for ingress and egress traffic in accordance with some aspects of the disclosure;

FIG. 3 is a conceptual illustration of an AI defense controller, a management loop of the AI defense controller, and a runtime loop of the AI defense controller in accordance with some aspects of the disclosure;

FIG. 4 is a sequence diagram of an AI defense controller used in an enterprise in accordance with some aspects of the disclosure;

FIG. 5 is a conceptual block diagram illustrating a shallow inspection pipeline and a deep inspection pipeline for natural language prompts and answers in accordance with some aspects of the disclosure;

FIG. 6 illustrates a block diagram of a data path pipeline and integration with hardware in accordance with some aspects of the disclosure;

FIG. 7 illustrates signatures of embeddings and high entropy signatures indicative of malicious prompts in accordance with some aspects of the disclosure;

FIG. 8 is a flowchart illustrating an example process of an AI defense controller for enterprises in accordance with some aspects of the disclosure; and

FIG. 9 is a diagram illustrating an example of a system for implementing certain aspects of the present technology.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Example Embodiments

Examples are described herein in the context of an artificial intelligence (AI) and machine learning (ML) defense controller for prompt and answer inspection. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

Machine learning, AI, and neural networks have evolved due to advances in deep learning, generative AI, and large-scale computing power. Transformer architectures, such as generative pretrained transformer (GPT) and bidirectional encoder representations (BERT) enable more human-like text generation, summarization, and reasoning and allow natural language conversations with machines. These models often are employed for natural language functions such as the conversion of unstructured, human-readable text into more structured data for various purposes. Other advances include diffusion models with enhanced generative AI to create images, videos, and music audio.

The models that drive services for AI-based functions are not easily deployed on local resources because the models use parallelization of computations, generally with tensor processing units (TPUs), graphics processing units (GPUs), and other neural processing units (e.g., neural engines, neural network processing units (NNPUs), etc.). These services are primarily cloud-native and require the transmission of natural language prompts and corresponding answers to those prompts across the network. The custom training of these models may also require the transmission of significant volumes of data to cause further training or adapters to learn new information within a specialized domain of knowledge.

Conventional network security is typically deployed using firewalls, intrusion detection, and prevention systems, virtual private networks (VPNs), data loss prevention (DLP), and endpoint security tools that rely on signature-based detection, rule-based policies, and manual configurations to identify threats. Network security is analyzed by monitoring traffic patterns, blocking known malicious signatures, and enforcing predefined access controls to protect networks and devices. Modern, AI-powered cyber threats can adapt to and evade signature-based detection, exploit zero-day vulnerabilities, and extract sensitive information from protected networks.

Cloud-based applications and workloads are distributed across heterogeneous solutions (e.g., different cloud providers) and have different underlying services that operate with different variations, such as keys, endpoints, and other information. A multicloud defense system (MCD) is configured to abstract all of the variations across a cohesive platform to simplify the management of multicloud deployed applications by providing gateways that enforce policies for customers.

Disclosed are systems, apparatuses, methods, computer readable medium, and circuits for a multicloud gateway with inline natural language prompt inspection. According to at least one example, a method includes: decrypting, at a gateway of a multicloud defense system, an application stream from a plurality of packets; inspecting a request or a response in the application stream for natural language content in a payload of the request or the response; requesting, by the gateway of the multicloud defense system, authorization from a defense controller to send the natural language content to a destination address; and providing, to the destination address, the plurality of packets based on the authorization from the defense controller.

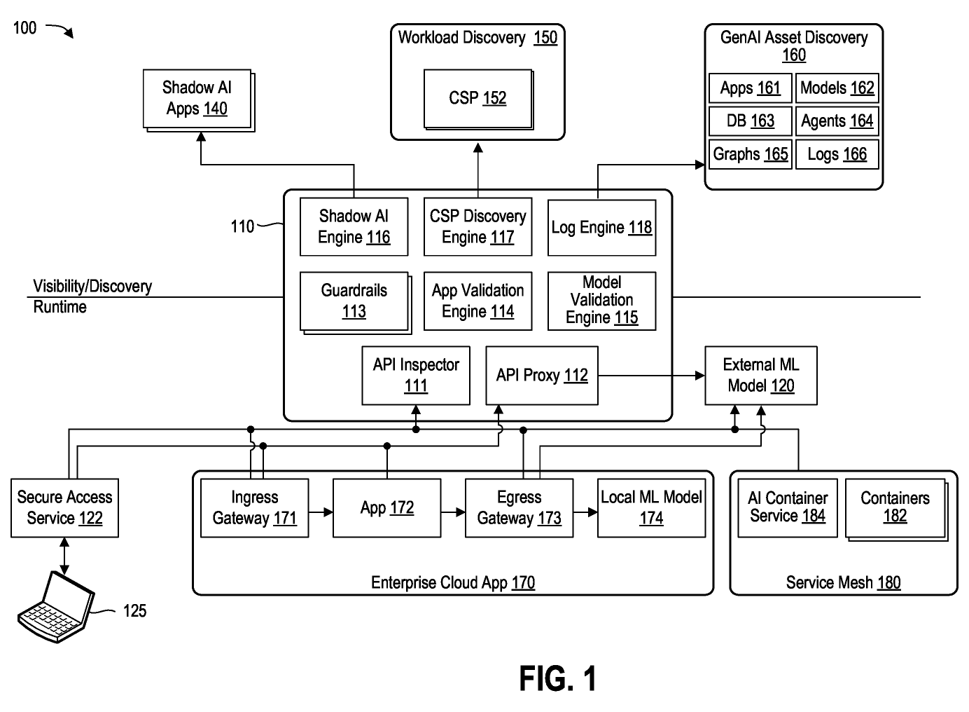

FIG. 1 is a conceptual block diagram of an AI defense controller system 100 in accordance with some aspects of the disclosure. In some aspects, the AI defense controller system 100 includes an AI defense controller 110 that is configured to transparently and securely inspect ingress and egress information to and from various ML and AI-based services. In some aspects, ML and AI herein may be used interchangeably to indicate non-deterministic processes performed by ML models including neural networks to apply learning based on various types of training. ML models (or AI models) can be relatively simple models (e.g., thousands of parameters such as a classifier) that can operate at line speed or can be large language models (LLMs) that have billions of parameters that use complex calculations to infer based on previous learning.

The AI defense controller 110 includes an application programming interface (API) inspector 111 and an API proxy 112 that interface with various components of an enterprise network. The AI defense controller 110 also includes at least one guardrail 113, which is a set of rules to invoke to ascertain safety of a request or response, identify potential data leakage, and so forth. In some aspects, the AI defense controller 110 also includes an application validation engine 114, a model validation engine 115, a shadow AI engine 116, a cloud service provider (CSP) discovery engine 117, and a log engine 118.

In some aspects, the AI defense controller 110 is configured to operate a runtime to handle network requests to perform various network security functions. For example, the API inspector 111 is configured to perform API request inspection by analyzing API requests for security threats, anomalies, and compliance issues without altering network flow. In some aspects, a secure access service 122 (e.g., a VPN user connected to an enterprise network) is configured to interface with an endpoint user 125 and may send an API request to the API inspector 111 to determine if the network user (e.g., the endpoint user 125) is permitted to access a particular destination address. The API inspector 111 may receive the request, which can include headers, a body, and execute one or more guardrails 113 to determine whether to allow or block the request. In some aspects, the AI defense controller 110 may also include an API proxy 112 to proxy network requests to manage, modify, and secure API requests between clients and backend services.

In some aspects, the guardrails 113 are sets of rules, heuristics, or models that are configured to analyze network requests of the AI defense controller 110. For example, a guardrail 113 can include conventional heuristic rules to allow/deny traffic, such as by rate-limiting input or output from an ML model. In some aspects, a guardrail 113 may also be an ML model that classify network data into various types of classifications, such as safe/not safe, malicious activity type, benign activity type, and so forth. For example, a guardrail 113 can be configured to identify code execution requests, which may be strictly forbidden, or a cross-site script (XSS) injection request, and so forth. The guardrail 113 can include a shallow path for an initial assessment of the contents of the packet and a deep path for a detailed assessment of the contents of the packet. For example, the shallow path can be performed on every packet and, when a packet is identified as potentially suspicious based on the guardrail 113, a deep path inspection can be invoked.

In some aspects, the AI defense controller 110 also includes a visibility/discovery phase for identifying assets and assessing those assets. The visibility/discovery phase includes an application validation engine 114 that is configured to assess application security posture. In some aspects, the application validation engine 114 is configured to inject a known repository of exploits and other malicious actions to determine if the application provides undesirable responses, indicating that the application is subject to potential exploits. In some aspects, application validation engine 114 can be integrated into a third-party platform to receive continuous updates to test internal or external applications. For example, native applications can be configured with a webview framework (e.g., Electron) that uses an hypertext markup language (HTML) renderer for rendering the application, and the application validation engine 114 may test various injection techniques (e.g., XSS, cascading style sheet (CSS) injections using pseudo-selectors such as :has(), etc.).

The AI defense controller 110 can also include a model validation engine 115 configured to inject a known repository of exploits and other malicious actions to determine if an ML model provides undesirable responses, indicating that the model is subject to potential exploits. Similar to the application validation engine 114, the model validation engine 115 can be integrated into a third-party platform to receive continuous updates to test internal or external models.

The application validation engine 114 and the model validation engine 115 are continually evolving to add new threats and malicious acts and provide a significant volume of information that can be used to identify weaknesses and other potential attack vectors. In some cases, the responses from targets of the application validation engine 114 and the model validation engine 115 can be used to generate a repository of information and identify characteristics representative of attacks on models and applications. In turn, the AI defense controller 110 can use the characteristics representative of attacks to continually adapt the guardrail 113 to identify malicious acts and data exfiltration attempts.

The shadow AI engine 116 is configured to detect unsanctioned usage of one at least one shadow AI application 140 and record data pertaining to usage of that shadow AI application 140. In some aspects, a shadow AI application 140 is an unsanctioned model that is being used and is able to be accessed through an interface. For example, CSPs can enable access to an ML service (e.g., OpenAI, Anthropic, etc.) via a gateway that handles certain traffic mechanisms (e.g., retry mechanisms such as circuit breakers) and ensure correct service, such as a streaming response. In some aspects, the shadow AI engine 116 is configured to identify usage of the shadow AI application 140 and records information pertaining to its usage, such as recording headers, payloads, and responses. In some cases, the shadow AI engine 116 may detect a request to an unauthorized domain and redirect usage through an unsupported interface (e.g., the CSP gateway) to allow the shadow AI engine 116 to record information pertaining to the usage of the model.

In some aspects, the shadow AI engine 116 is also configured to detect the usage of a model by other applications. In many cases, current applications are employing API access to ML services to reduce heavy data entry, improve authentication, and provide enhanced user experiences. For example, the shadow AI engine 116 can detect when such applications are employing indirect access to ML models based on signatures in responses, or natural language in network requests.

In some aspects, the AI defense controller 110 includes a workload discovery service 150 using a CSP discovery engine 117. In some aspects, the CSP discovery engine 117 is configured to connect to one or more CSPs 152 to inspect for services, models, agents, and workloads that are available to the AI defense controller 110. The CSP discovery engine 117 identifies allocated virtual private cloud (VPC) instances and allows the AI defense controller 110 to dynamically build a repository of applications and services that are exposed to the AI defense controller 110 without requiring explicit configuration. The CSP discovery engine employs a combination of heuristics and models to identify various endpoints and models.

The AI defense controller 110 also includes a log engine 118 to implement a generative AI asset discovery service 160 that connects various services. In some aspects, the generative AI asset discovery service 160 includes application module 161 to scan and identify applications that make use of generative AI services based on API usage, library dependencies, or prompt patterns. The generative AI asset discovery service 160 may include a model inventor 162 to catalogue all detected AI models along with metadata such as their names, versions, hosting locations, and, if available, information about their training data. In some cases, database 163 (e.g., vector databases, relational databases, document databases, etc.), may identify and track databases associated with generative AI systems, such as vector databases, relational databases storing embeddings, and document databases used for storing prompts and responses. The generative AI asset discovery service 160 includes an agent module 164 to detect autonomous agents (e.g., AutoGPT instances or LangChain-based systems) and mapping their tasks, memory storage, and external interactions. A graph service 165 ma reconstruct or detect knowledge graphs generated by AI models or retrieval-augmented generation (RAG) systems by identifying relationships between data entities. The generative AI asset discovery service 160 may also include CSP logs 166 that connects to the various CSPs and identifies ML-based usage. For example, the log engine 118 is configured to access CSP logs 166 and inspect the logs 166 for generative AI application usage. For example, the log engine 118 may access domain name server (DNS) logs, access logs, flow logs, model logs, and so forth. In some aspects, the various logs can surface information that be analyzed for natural language queries and corresponding responses to the natural language queries.

The AI defense controller 110 can be integrated at multiple levels to provide a holistic view of the usage of AI and ML-based functions and defensive coordination at different levels of abstraction. For example, the endpoint user 125 (e.g., a VPN user) can request the API inspector 111 for permission to access an external ML model 120 or API proxy 112 to proxy the request to the external ML model 120.

The AI defense controller 110 can also be integrated into an enterprise cloud application 170 that is configured in heterogeneous CSP services. The enterprise cloud application 170 may be integrated into a multicloud defense system that includes an ingress gateway 171 that is transparent and provides various security mechanisms, such as distributing consistent firewall configuration from a centralized control system (not shown). For example, the ingress gateway 171 may also include a web application firewall (WAF) configured for stateful inspection of requests and responses to an application 172. The ingress gateway 171 can also request a safety inspection of a request from the AI defense controller 110 using the guardrail 113.

The enterprise cloud application 170 may include an application 172 including generative AI features as part of an external ML model 120 or a local ML model 174 within the enterprise cloud application 170. For example, the external ML model 120 can be fine-tuned trained version of an ML model service (e.g., OpenAI, Anthropic, etc.) to provide public enterprise information to consumers of the application 172. Models can be trained to provide chatbot functions to assist customers in identifying products and services. In another example, external models can be trained based on real-time functions to provide voice interactivity for customer support functions, and so forth.

In some aspects, an egress gateway 173 can perform a stateful inspection of the requests from the application 172 to the external ML model 120 or the local ML model 174, using the API inspector 111 for example, to ensure that the prompts and information returned from the external ML model 120 or the local ML model 174 are safe and aligned with business purposes. In some cases, prompts can include malicious instructions to attempt to cause the external ML model 120 or the local ML model 174 to reveal proprietary information. The AI defense controller 110 identifies these malicious instructions and answers to those prompts to prevent unauthorized access to sensitive information. In some aspects, the AI defense controller 110 can also include guardrails 113 for training these models to ensure that proprietary information and personally identifiable information do not touch these models during fine-tuning. In some aspects, the egress gateway 173 may be configured in a pipeline with other components, such as inline inspection after the API proxy 112.

In some aspects, the AI defense controller 110 can be integrated into a service mesh 180 that is executed in various data centers. For example, the various services can be distributed across a plurality of containers 182 (e.g., Kubernetes) and a container service 184 that provides networking, observability, and security for container-based workloads. For example, the container service 184 may use an extended Berkeley Packet Filter (eBPF) to perform proxy, load balancing, authentication, and observability functions such as enforcing policies, performing deep packet inspection, and applying security rules to application traffic. The container service 184 can be integrated into the AI defense controller 110 to allow stateful AI defense such as denying and allowing traffic based on AI policies.

The AI defense controller 110 provides multiple integration points to allow stateful inspection of prompts and answers to those prompts. In some aspects, the AI defense controller 110 is configured to inspect prompts (e.g., in hypertext transfer protocol (HTTP) requests) to identify the safety of the prompts and inspect answers to those prompts, and identify the safety of the answers. The answers are a stream of data (e.g., a stream of HTTP responses) to allow inference operation to provide partial data based on the time-based nature of inference. The AI defense controller 110 is configured to analyzes the answer as the responses are being received to make a determination regarding the safety of the response. In some cases, the AI defense controller 110 can analyze the prompt and the response to determine the safety of the prompt and the response together.

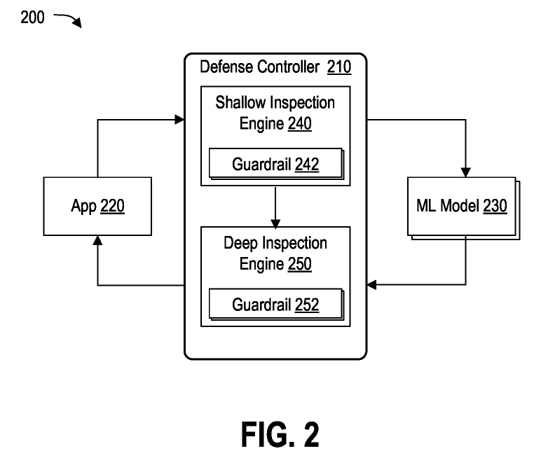

FIG. 2 is a conceptual diagram 200 of an inspection path of the AI defense controller system for ingress and egress traffic in accordance with some aspects of the disclosure. In some aspects, the defense controller 210 is configured to receive prompts from an application 220 that uses an ML model 230 (e.g., the external ML model 120 or the local ML model 174) for various operations. The application 220 can be a browser-based application (e.g., a front-end JavaScript bundle for rendering a UI) or a native application that uses a network connection to access the ML model 230.

The application 220 is configured to send a request including a prompt to the defense controller 210 transparently. For example, the secure access service 122 in FIG. 1 may request permission to send the request from an API inspector (e.g., the API proxy 112) or may send the request to an API proxy (e.g., the API proxy 112 in FIG. 1).

The defense controller 210 includes a shallow inspection engine 240 that is configured to analyze the request using one or more guardrails 242. For example, the guardrails include a combination of heuristic and model-based functions that are trained to identify safety. In one example, the guardrails may be configured to identify signatures that represent patterns associated with safe and unsafe prompts. The guardrails 242 renders a safety verdict to determine whether the prompt is safe or whether a detailed analysis of the prompt should be performed.

In some aspects, when the guardrails 242 identify potentially unsafe or malicious prompts, a deep inspection engine 250 is invoked to use one or more guardrails 252. In some aspects, the guardrails 252 of the deep inspection engine 250 provide a comprehensive review of the prompt to ensure that the shallow inspection engine 240 does not provide a false positive. For example, the deep inspection engine 250 may include a large language model or a reasoning ML model that can identify a reason that a particular prompt was denied, such as an attempt to retrieve an external node and inject that code into a prompt or a response. To the extent the deep inspection engine 250 identifies a malicious prompt, the deep inspection engine 250 may deny transmission of the prompt and record information pertaining to the prompt. To the extent that the deep inspection engine 250 identifies a potentially malicious prompt, the deep inspection engine 250 may log the prompt for subsequent analysis and permit the prompt, subject to additional inspection of the response. In some cases, malicious prompts can be converted into probes or test cases to allow components of the defense controller 210 (e.g., the application validation engine 114 and the model validation engine 115) to probe services, applications, and models.

The ML model 230 may provide a response including a portion of an answer to permitted prompts. The defense controller 210 is configured to inspect the answer using the shallow inspection engine 240 and the deep inspection engine 250 similar to the prompt. In some aspects, the inspection of the answer from the ML model 230 may be stateful and ensure that the prompt and the answer are sufficiently related. For example, an answer generally incorporates features of a prompt, and failure to incorporate any feature may be an indication of hijacking of the prompt or bootstrapping of other information into the prompt to generate an unsafe or malicious response.

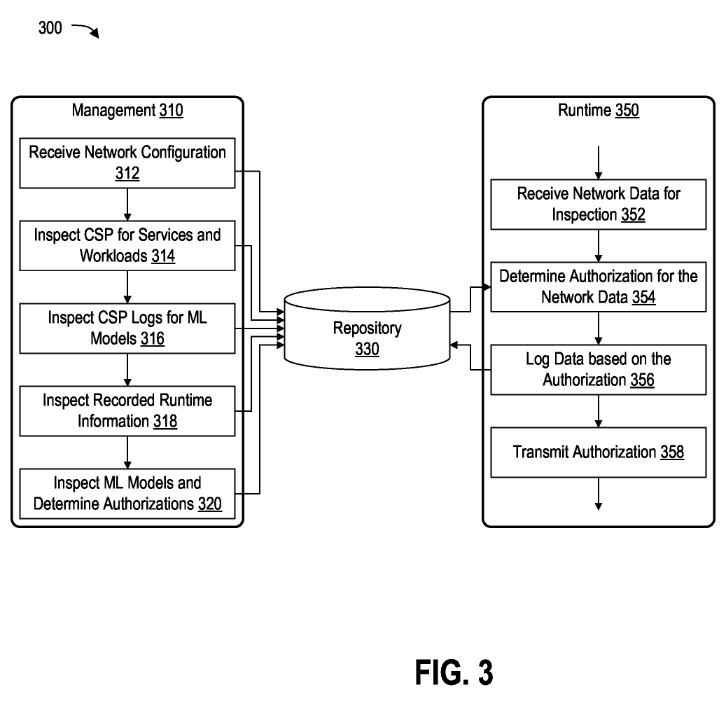

FIG. 3 is a conceptual illustration of an AI defense controller 300, a management loop 310 of the AI defense controller, a repository 330 for storing information for the AI defense controller 300, and a runtime loop 350 of the AI defense controller in accordance with some aspects of the disclosure.

In some aspects, the AI defense controller 300 is configured to execute the management loop 310 to identify attack vectors, identify ML model usage, monitor applications for unsanctioned ML usage, and vectors of potential concern. In one aspect the management loop 310 may receive network configuration associated with various aspects of the network at block 312. For example, an administrator may provide additional information pertaining to a VPC in a CSP or other cloud workload to a multicloud defense system. The multicloud defense system is configured to provide security-based infrastructure to heterogeneous cloud configurations.

In some aspects, at block 314, the management loop 310 may inspect each CSP for services and workloads using various techniques. CSP workloads are dynamic and frequently changing, such as new services offered, new endpoints, and new models that are made available. The management loop 310, at block 314, uses various tools (e.g., a CSP API, a network inspection tool, etc.) to identify these interfaces. For example, the management loop 310 can inspect logs to identify potential endpoints, probe for API endpoints, and so forth. In some cases, as part of block 314, the management loop 310 may execute an ML model to identify published resources to extract services and workloads being offered by the CSP.

At block 316, the management loop 310 may inspect CSP logs for usage of ML models by applications and other resources. For example, identification of ML models can be identified based on a fully qualified domain name (FQDN), larger payloads, and streaming responses. In some aspects, as part of block 316, the management loop 310 can cross reference other resources (e.g., logs in the multicloud defense system, access logs by secure clients, etc.) to identify issues.

At block 318, the management loop 310 may also inspect recorded runtime information. For example, the management loop 310 may record information of previous instances and have various caches that identify resources that may warrant deeper inspection. In some cases, the block 318 can be used to identify patterns and information that are indicative of past attack vectors and use the information to identify malicious actors based on source IP address.

At block 320, the management loop 310 may also inspect ML models and determine an authorized scope based security information. For example, the management loop 310 may also receive threat intelligence from third party services (e.g., Talos) related to ML models and various attack vectors for the AI defense controller 300 to identify. At block 320, the management loop 310 may perform a detailed inspection of local ML models (e.g., scanning a package container for malicious content). The management loop 310 can also execute a collection of adverse prompts (e.g., an updated subset of the adverse prompts) and evaluate the responses for adverse responses.

In the event the management loop 310 identifies malicious prompts, at block 320, the management loop 310 (e.g., a component of the management loop 310) may generate an authorization scope for the ML model. For example, the authorization scope excludes prompts that have a high density of embeddings in a particular vector direction that represent a malicious prompt or an unsafe response.

The management loop 310 is configured to generate information and store information in the repository for the runtime loop 350. The runtime loop 350 is invoked based on a request for an external device (e.g., the secure access service 122, the enterprise cloud application 170, the service mesh 180, etc.) for authorization or proxy functions.

For example, at block 352, the runtime loop 350 may receive network data for inspection. The network data may be a network request (e.g., to proxy at a multicloud defense gateway) or an authentication request (e.g., the API inspector 111). At block 354, the runtime loop 350 is configured to determine authorization for the network data. For example, at block 354, runtime loop 350 may use recorded information within the repository 330 to identify malicious or benign requests to determine if the request or response is authorized.

At block 356, the runtime loop 350 may log data based on the authorization. In some cases, the authorization may be to allow and log, but in other cases may be allowed without logging. At block 358, the runtime loop 350 can transmit the authorization to the requesting device, which then performs the corresponding action.

In this way, the management loop 310 monitors, inspects, and updates security information in the repository 330 to identify malicious network traffic associated with ML models. The runtime loop 350 uses the information identified by management loop 310 based on the resources available and exposed to clients to limit ML-based traffic.

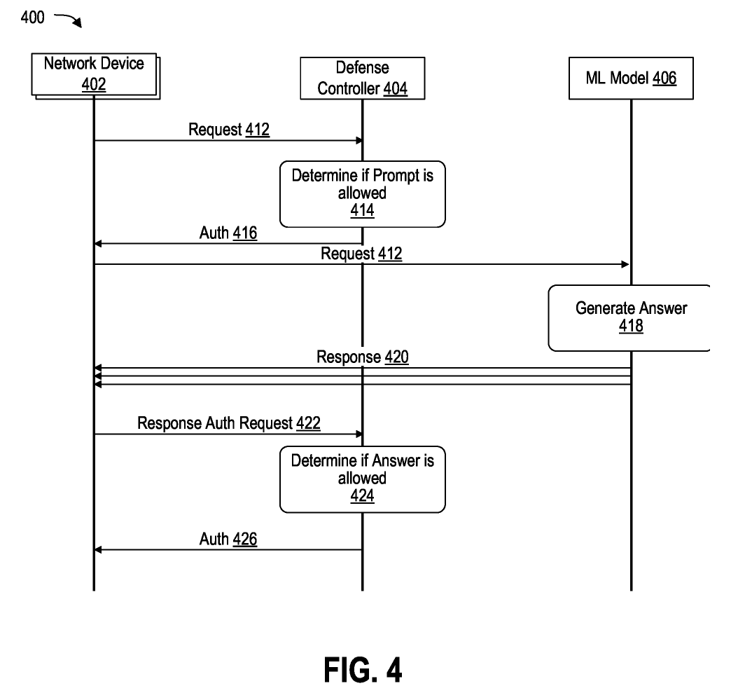

FIG. 4 is a sequence diagram 400 of an AI defense controller used in an enterprise in accordance with some aspects of the disclosure. For example, the sequence diagram 400 illustrates that the prompts and answers are evaluated when returned to at least one client device 402. The client device 402 can be secure access clients (e.g., the secure access service 122 in FIG. 1), cloud applications (e.g., the enterprise cloud application 170 in FIG. 1), or containers (e.g., the containers 182 in FIG. 1).

In some aspects, a client device 402 may send a request 412 to the defense controller 404 to make a determination whether a prompt in the request 412 is safe or unsafe. At block 414, the defense controller 404 makes a determination whether the prompt in the request 412 is allowed. In some aspects, the block 414 returns an authentication response 416 to the client device 402. For example, the client devices 402 may be a multicloud gateway that is capable of decrypting the transport layer security (TLS) encryption at line rate due to a hardware accelerator and can inspect the payload. In some aspects, the line rate corresponds to maximum theoretical data transmission speed that the device (e.g., the defense controller 404) can support on a given interface and represents the physical layer (e.g., Layer 1) speed of a network connection. Line rates are typically measured in bits per second (bps), such as 1 Gbps, 10 Gbps, or bGbps.

The client devices 402 may then send the request 412 to the ML model 406, which generates an answer 418 to the prompt in the request 412. The ML model 406 may stream a plurality of responses 420 due to the client device 402. In some cases, the client devices 402 may send a response authentication request 422 to the defense controller 404, which determines if the answer is allowed at block 424. The defense controller 404 provides an authentication response 426 to the client device 402, which then performs the corresponding response (e.g., allow, allow and log, deny and log, etc.)

In some aspects, block 424 can also be performed within the scope of block 414. For example, the defense controller 404 may determine if the answer corresponds to the prompt in the request 412. For example, the defense controller 404 may employ a model to summarize the response and the prompt, generate embeddings, and determine if the embeddings are sufficiently aligned using various vector similarity techniques.

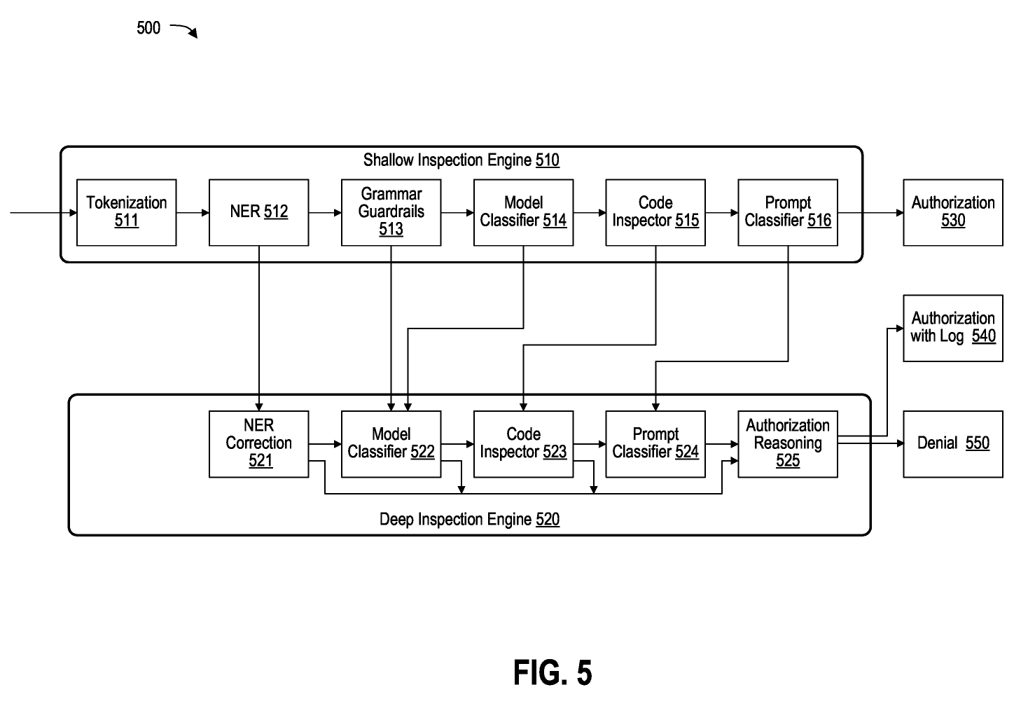

FIG. 5 is a conceptual block diagram illustrating an inspection engine 500 of an AI defense controller for filtering unsafe natural language prompts and answers in accordance with some aspects of the disclosure. The inspection engine 500 includes a shallow inspection engine 510 (e.g., the shallow inspection engine 240) and a deep inspection engine 520 (e.g., the deep inspection engine 250). In some aspect, the shallow inspection engine 510 and the deep inspection engine 520 are part of the AI defense controller (e.g., the defense controller 404, the AI defense controller 300, the AI defense controller 110, etc.) and shallow inspection engine 510 identifies high confidence issues and provides authorization to content (e.g., a prompt or an answer) based on passing inspection of the natural language content at each pipeline components.

In some aspect, the shallow inspection engine 510 may initially perform tokenization 511 of the natural language content (e.g., the prompt or the response). In some aspects, tokenization breaks down text into smaller units, such as words (e.g., a named entity such as a person’s name), subwords, or characters that represent a single concept. In some aspects, a named entity recognizer (NER) 512 is configured to identify whether the natural language content includes sensitive information or personally identifiable information (e.g., unique information that can be mapped to a single individual, such as a social security number, etc.). In some aspects, the NER 512 is trained to identify sensitive information unique to an organization, such as project names, terms specific to the organization, etc. If the NER 512 identifies the sensitive information and determines the natural language content is unsafe, the NER 512 provides the tokens to the NER correction engine 521.

In some aspects, if the NER 512 does not identify the natural language content is unsafe, the tokens are provided to grammar guardrails 513. In some aspects, the grammar guardrails 513 are trained to identify valid grammar that is understandable to an ML model. For example, the grammar guardrails 513 can use various processing techniques to statistically ensure that the grammar is natural language that is representative of human input. In the event the tokens are deemed safe by the grammar guardrails 513, the tokens are provided to the model classifier 514 to identify a model and determine whether tokens are safe for input into the model. In some aspects the model classifier 514 may include an encoder to encode the tokens into embeddings.

In the event the tokens or embeddings are deemed safe by the model classifier 514, the tokens (and/or embeddings) may be provided to a code inspector 515 to identify unsafe code and commands. In some aspects, the code inspector 515 can perform an analysis to identify various aspects to jailbreak, execute a shell, or other exploit that would cause adverse reactions (e.g., opening a shell, running an unsafe command, etc.). In the event that code is present and that code is safe, or if no code is present in the tokens, the tokens (and/or embeddings) are provided to a prompt classifier 516.

The prompt classifier 516 performs an analysis of the tokens and/or embeddings to ascertain whether the prompt is safe. For example, the prompt classifier 516 can include an encoder to encode the tokens into a vector space that represents malicious prompts and determines based on a similarity (e.g., cosine similarity, dot product, Euclidean distance, etc.) to other malicious prompts. In the event the prompt classifier 516 deems the prompt (or answer) safe, the shallow inspection engine 510 may provide authorization 530 for the prompt. For example, the AI defense controller (e.g., the defense controller 404, the AI defense controller 110, etc.) can respond to a proxy identifying the prompt as safe.

In the event any of the engines in the shallow inspection engine 510 identify the tokens as potentially unsafe, the engine provides the tokens to the deep inspection engine 520 for a deeper inspection. For example, the shallow inspection engine 510 may limit the number of embeddings using a first number of embeddings (e.g., 768 vectors) and the deep inspection engine 520 may use a larger number of embeddings (e.g., 3072 vectors). The deep inspection engine 520 is thereby able to perform a more comprehensive inspection to identify and possibly correct the tokens.

In some aspects, if the NER 512 identifies unsafe tokens and information, such as sensitive information and personally identifiable information, a NER correction engine 521 may be invoked in the deep inspection engine 520 to ascertain if the named entities and personally identifiable information can be removed. In some cases, the NER correction engine 521 can be a combination of a large language model and heuristics configured to determine whether a prompt or answer has sensitive information. The NER correction engine 521 can be configured to replace the sensitive information in some cases. In the event the NER correction engine 521 cannot replace the sensitive information, the NER correction engine 521 may provide the tokens to an authorization reasoning engine 525.

In the event the NER correction engine 521 can correct the tokens (e.g., by replacing personally identifiable information or named entities associated with sensitive information of an enterprise), the NER correction engine 521 provides the tokens to a model classifier 522. In some aspects, the model classifier 522 may be similar to the model classifier 514 but may include additional layers of detection to classify the model and identify the safety of the prompt with respect to the model. For example, the model classifier 522 may use more embeddings as compared to the model classifier 514. In the event the model classifier 522 deems the tokens unsafe, the tokens are provided to the authorization reasoning engine 525.

In some cases, the model classifier 522 identifies the tokens as safe based on the model and provides the tokens to the code inspector 523, which may inspect the code and instructions for malicious content. For example, the code inspector 523 can include a pattern matching (e.g., regular expression) engine that is configured to perform exhaustive forward and backward searching to identify malicious patterns. In some cases, the code inspector 523 can execute the instructions in a sandbox environment (e.g., in a container or virtual machine running in the AI defense controller). In the event the code inspector 523 identifies unsafe code, the tokens are then provided to the authorization reasoning engine 525.

After the code inspection, the deep inspection engine 520 is configured to execute a prompt classifier 524 similar to the prompt classifier 516. The prompt classifier 524 provides a more exhaustive analysis and additional layers of detection. For example, the prompt classifier 516 may use a cosine similarity, but the prompt classifier 524 may evaluate embeddings using cosine similarity, dot product, and Euclidean distance with more vectors.

In some cases, the prompt classifier 516 is configured to use other techniques different from or in conjunction with vector similarity techniques. The prompt classifier 516 may comprise a ML model, including an encoder-based architecture such as BERT or a decoder-based architecture such as LLAMA or an autoregressive model. The prompt classifier 516 may further include a taxonomy of classifiers that categorizes prompt classifiers and model classifiers according to specific types of threats or misuse cases. Specialized classifiers may be implemented to detect targeted behaviors including, but not limited to, prompt injection attacks, toxicity, and other security or content integrity risks. The prompt classifier 516 may also include shallow inspection engines and deep inspection engines, each configured to utilize distinct analytical techniques including vector similarity analysis, machine learning-based classification, encoder model inspection, and decoder model evaluation. In certain aspects, the prompt classifier 516 may incorporate domain-specific small language models to perform enhanced classification within defined application domains or to address specific threat vectors.

The authorization reasoning engine 525 is configured to receive the tokens from any of the prior analyses and identify a reason for the authorization or denial of the authorization. As described above, the authorization reasoning engine 525 can receive the tokens based on an unsafe identification from earlier engines (e.g., the NER correction engine 521, the model classifier 522, etc.). In the event the tokens of the prompt are unsafe, the authorization reasoning engine 525 provides instructions to deny and may then infer a reason for the denial. For example, the authorization reasoning engine 525 can use a reasoning model to infer the content and reasoning based on information provided from earlier engines (e.g., an identification of the model from the model classifier 522, the identification in instructions deemed unsafe from the code inspector 523, etc.). For example, the authorization reasoning engine 525 may be a reasoning model (e.g., LLAMA-3.2-reasoning) trained with an adapter to explain a reason why the prompt was deemed unsafe. In some aspects, the authorization reasoning engine 525 may output an authorization 540 with a log instruction to record the reasoning for the authorization (e.g., if all engines in the deep inspection engine 520 deem the prompt safe). In the event any engine in the deep inspection engine 520 deems the prompt unsafe, the authorization reasoning engine 525 outputs a denial 550 of the prompt, which can also be logged with the reason identified by the authorization reasoning engine 525.

In some aspects, the inspection engine 500 is an example and various permutations can made based on changes to ML security operations. For example, fast pattern matching in hardware may be implemented, FQDN filtering can be selectively applied to process some prompts differently, and so forth.

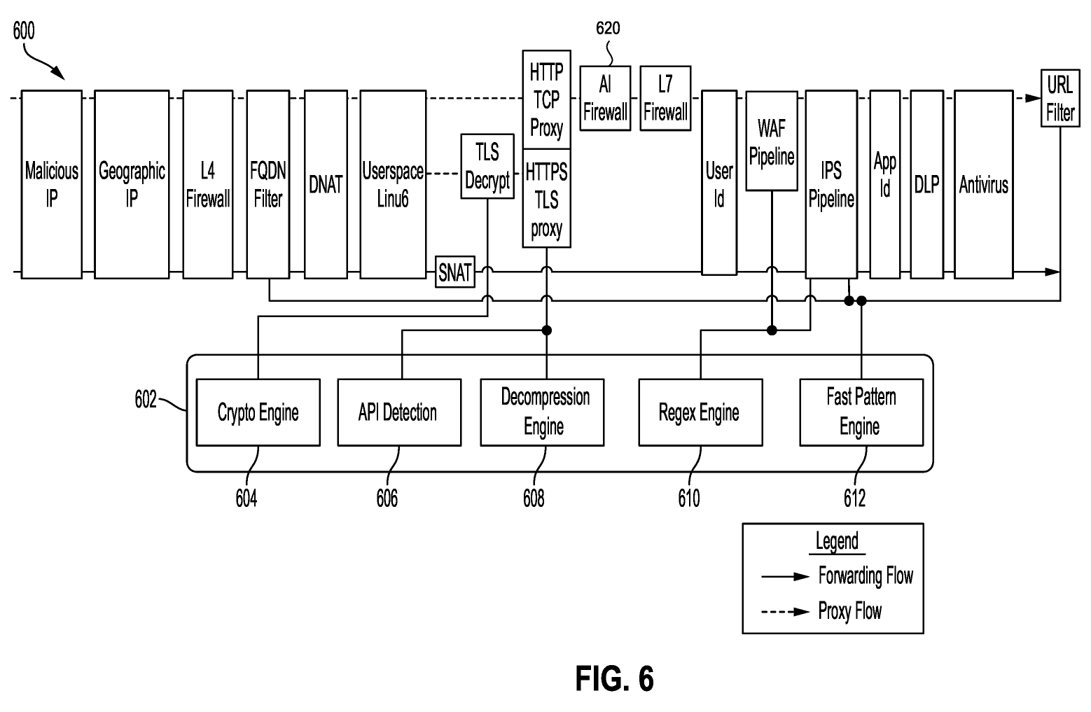

FIG. 6 illustrates a block diagram of a data path pipeline 600 and integration with hardware in accordance with some aspects of the disclosure.

In some aspects, the data path pipeline 600 comprises a single-pass firewall architecture that uses a single-pass flow without expensive context switches and memory copy operations. In a single-pass flow, processing is not duplicated multiple times on a packet. For example, TCP/IP receive and transmission operations are performed a single time. This is different from existing next-generation firewalls (NGFW). The data path pipeline 600 uses fibers with flexible stages completely running in user space and, therefore, does not incur a penalty for kernel-user context switches, which are expensive in high bandwidth and low latency operations. The data path pipeline 600 provides advanced web traffic inspection comparable to WAFs to secure all traffic flows and break the attack kill chain in multiple places, raising the economic costs for attackers. The data path pipeline 600 also captures packets of live attacks into a cloud storage bucket without significant performance degradation and enables a rule-based capture on a per-session and attack basis.

The data path pipeline 600 is also configured to be flexible and stages of processing are determined on a per-flow basis. For example, application 1 to application 2 may implement an L4 firewall and IPS inspection, application 3 to application 4 may implement an L4 firewall, a TLS proxy, and IPS, and an internet client to web application 6 implements an L4 firewall, TLS proxy, IPS, and WAF.

In some aspects, the data path pipeline 600 also includes an AI firewall 620 is configured to handle network flows based on requests and responses from AI and ML models. In some aspects, because the TLS proxy, which terminates a TLS session and decrypts the packet, the AI firewall 620 can request an AI defense controller (e.g., the AI defense controller 110 in FIG. 1) for authorization regarding the request or a response. In some aspects, conventional network devices (e.g., routers, switches) cannot handle a deep packet inspection of each packet at line rate because deep packet inspection invokes processing a higher layers in software, which has a lower throughput than hardware processing at line rate (e.g., Gbps). The AI defense controller may have higher latency due to the processing of the request, and the AI firewall may throttle requests to the AI defense controller. For example, the data path pipeline 600 runs at line rate to inspect the payload of each packet and a natural language prompt or response is encrypted in the payload (e.g., in a TLS session) which requires deep packet inspection to identify. The configuration of the data path pipeline 600 allows line rate deep packet inspection. In some cases, the AI defense controller may also block requests based on throttling AI defense requests to 100 every 100 milliseconds, for example. For example, AI defense controller cannot execute at line rate of a network device based on the time-domain nature of inference and too many active inspection requests to the AI defense controller can cause a bottleneck that compounds traffic issues.

In some aspects, the data path pipeline 600 includes various filters (e.g., malicious IP filter), geographic IP filter, FQDN filter) to filter both forwarding flows and proxy flows, as well as an L4 firewall to restrict traffic based on conventional techniques.

The data path pipeline 600 may also be integrated with a hardware offload 602 (e.g., a field programmable gate arrays (FPGA) of a cloud provider, an application specific integrated circuit (ASIC), etc.) that includes additional functionality that does not impact throughput. In one aspect, a cloud provider may offer a hardware offload or an accelerator function to implement a specialized function. For example, the hardware offload 602 includes a cryptographic engine 604, an API detection engine 606, a decompression engine 608, a regex engine 610, and a fast pattern engine 612 to offload operations into hardware.

In one aspect, the data path pipeline 600 includes high throughput decryption and re-encryption to enable inspection of all encrypted flows using the cryptographic engine 604. By contrast, traditional NGFWs provide a throughput of around 10% for inspecting encrypted flows. The data path pipeline 600 may use a decompression engine 608 to decrypt compressed traffic and perform deep packet inspection. For example, the data path pipeline 600 also uses a userspace Linux TCP/IP driver, in addition to network address translation (NAT) in conjunction with the API detection engine 606 and the decompression engine 608 to eliminate problematic and malicious flows.

The data path pipeline 600 includes a transparent reverse and forward proxy to isolate clients and servers without exposing internal details, a layer 7 firewall to rate limit and protect applications and APIs, and secure user access by looking up end-user-specific identity from an identity provider (IDP) and provide zero trust network access (ZTNA). The data path pipeline 600 includes a WAF pipeline and an IPS pipeline to detect malicious and problematic flows in conjunction with a regex engine 610 and a fast pattern engine 612. For example, the WAF pipeline may implement protection for web applications, including OWASP Top 10, using a core ruleset and application-specific rules for frameworks and common content management tools like PHP, Joomla, and WordPress. The data path pipeline 600 includes IDS and IPS to block known vulnerabilities and provide virtual patching until the applications can be patched with updated security fixes, application identification to block traffic based on client, server or application payload, DLP loss and filtering, URI filtering, antivirus and anti-malware features to prevent malware files from being transferred for ingress (malicious file uploads), east-west lateral attacks (moving toolkits) and egress flows (e.g., botnets).

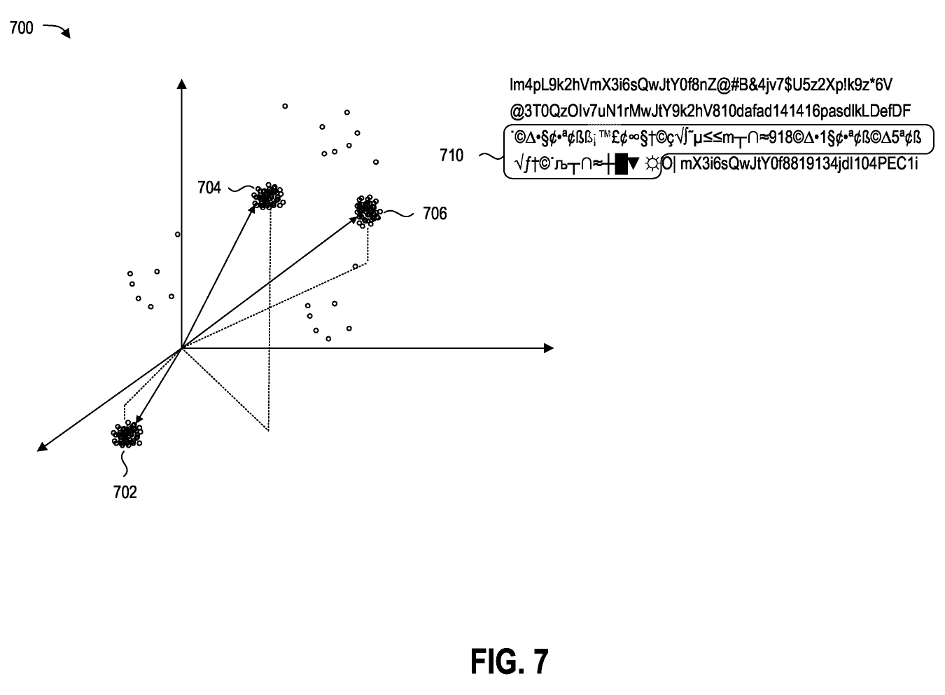

FIG. 7 is a graph 700 conceptually illustrating signatures of embeddings and high entropy signatures indicative of malicious prompts in accordance with some aspects of the disclosure. In some aspects, the graph illustrates that malicious content can be represented by high density vectors. For example, clusters 702, 704, and 706 have a significantly higher density than other embeddings, indicating that the natural language emphasizes the embeddings represented by clusters 702, 704, and 706. The clusters 702, 704, and 706 provide densities that are representative of specific concepts that can be mapped to malicious actions.

The clusters 702, 704, and 706 are examples of patterns that can be identified by the AI defense controller, similar to identifying high density concepts, such as embedded content 710 in a binary file. The AI defense controller is configured to identify various patterns using different engines (e.g., as shown in FIG. 5) related to different types of attack vectors, such as code injection, and so forth.

For example, an adversarial attack applies small perturbations to input data to cause the model to make incorrect predictions. An adversarial attack may be identified by dissimilar vectors. In another example, a model inversion attack reconstructs input data from the output of the ML model, leading to privacy leaks. Model inversion attacks can be identified by identifying named entities (e.g., the NER 512) and eliminated by blocking or replacing the named entities. For example, sensitive names can be replaced with generic names by the NER correction engine 521.

In another example, model stealing attacks can be identified by repeated API queries to train a surrogate model (e.g., a Siamese model) that mimics a proprietary ML model. The AI defense controller can detect the patterns based on a number of repeated requests that have patterns of correlation across periods of time.

In another example, an evasion attack manipulates input data at inference time to bypass detection, such as changing a few pixels in an image to bypass facial recognition or modifying malware code to evade detection. The evasion attack can also be detected based on pattern recognition techniques across multiple requests. For example, the AI defense controller may use an in-memory cache (e.g., a redis database) to buffer previous requests and identify patterns across these requests.

In some aspects, the AI defense controller may develop a sematic cache that identifies patterns of application usage, malicious attacks, and other techniques. The semantic cache may be, for example, a bloom filter that identifies permitted scope based on various behaviors. A bloom filter is a space-efficient probabilistic data structure that quickly tests membership in a set, allowing false positives but no false negatives. In some cases, the AI defense controller may also distribute the semantic cache to other members (e.g., the secure access service 122, the enterprise cloud application 170, etc.) to allow fast and efficient identification of malicious prompts at edge devices, hardware accelerators, and so forth.

In some aspects, various types of transformations can be applied to the embeddings to generate complex pattern identification information, such as a Fourier transform mapped into different dimensions (e.g., a toroid or a finite field). In another aspect, the embeddings can be applied to a lattice transformation in multidimensional space (e.g., similar to post-quantum cryptography (PQC)). For example, LLM models can generate signatures based on patterns, biases, and artifacts that uniquely associate generated text with a specific model. PQC-hard problems help in membership inference for model detection by checking if a given text snippet resembles outputs from a suspected LLM and inferring training data or model lineage. In other aspects, the PQC-hard problems can be used to use query-based extraction attacks to identify hidden layers, architectures, or hyperparameters used in LLMs. In another aspect, PQC-hard problem can detect biases by testing if slight perturbations to input prompts cause systematic model-specific errors, which can help distinguish between LLM models based on response consistency. In other aspects, PQC-hard problems can be used in data poisoning to extract signatures. For example, by introducing controlled "canary" data into training and later checking if such patterns appear in LLM outputs, a specific LLM can be identified.

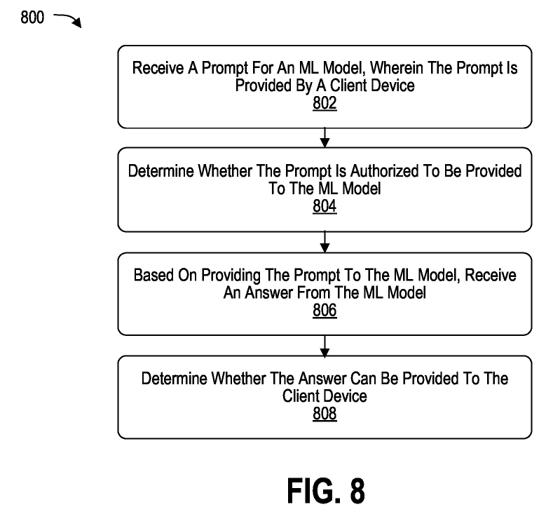

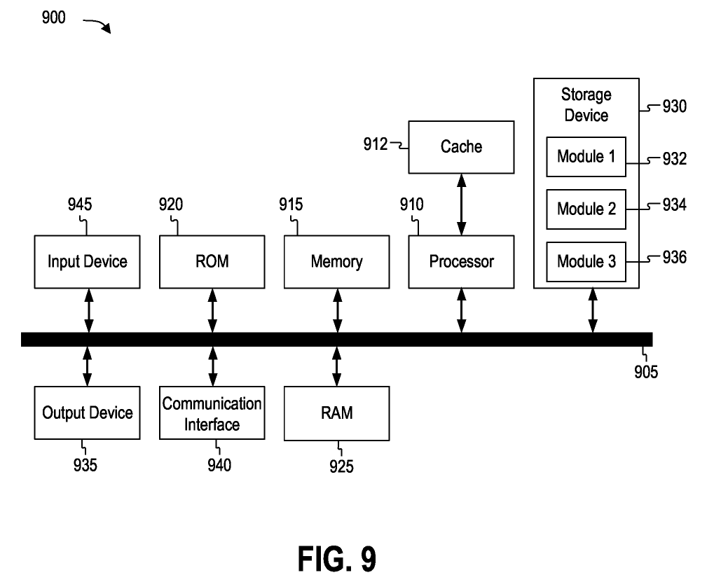

FIG. 8 is a flowchart illustrating an example process of an AI defense controller for enterprises in accordance with some aspects of the disclosure. The process 800 can be performed by a computing device (or apparatus) or a component (e.g., one or more chipsets, an SoC, one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 800 may be implemented as software components that are executed and run on one or more processors (e.g., CPU, GPU, DSP, NPU or neural engine, SoC, the processor 910 of FIG. 9, and/or other processor(s)).

In some aspects, the computing system, at block 802, may receive a prompt for an ML model. The prompt can be from, for example, a secure access client (e.g., the secure access service 122 in FIG. 1), a cloud application (e.g., the enterprise cloud application 170 in FIG. 1), or a service mesh (e.g., a container such as a container 182 in FIG. 1).

In some aspects, the computing system, at block 804, may determine whether the prompt is permitted to be provided to the ML model. In some cases, if the computing system blocks the prompt, the process may end at block 806. For example, the computing system can determine the prompt is not allowed, the model associated with the prompt cannot be used, the prompt for the model is not allowed, and so forth. A prompt that allowed may also be referred to as harmful or unsafe. Harmful or unsafe prompts may cause a liability to a customer or other interested party. For example, harmful or unsafe prompts can include leaking private information, illegal activity, or other unsupported content or activity.

In some aspects, the computing system, at block 806, may, based on providing the prompt to the ML model, receive an answer from the ML model.

In some aspects, the computing system, at block 808, may determining whether the prompt can be provided to a client. For example, the answer can be evaluated to ensure it does not invoke malicious actions at the client. As an example, the answer may attempt to break a sandbox by opening a remote file with malicious content. The answer may also inject instructions that invoke additional functions (e.g., a request to retrieve malicious content). The computing system identifies these malicious actions and blocks them.

In some cases, the prompt and the answer can be evaluated together to determine if the response should be provided to the requesting client. For example, if the prompt and the answer have different features, the different features can indicate that a system prompt to the ML model has been compromised.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as ROM 920 and RAM 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple^{TM} Lightning^{TM} port/plug, an Ethernet port/plug, a fiber optic port/plug, a proprietary wired port/plug, 3G, 4G, 5G and/or other cellular data network wireless signal transfer, a Bluetooth^{TM} wireless signal transfer, a Bluetooth^{TM} low energy (BLE) wireless signal transfer, an IBEACONTM wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”)symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A system for inspecting machine learning (ML) based payloads, comprising:
a runtime inspection engine configured to determine whether to allow a request or response to or from a first machine learning model based on an inspection of a payload of the request or the response,
wherein the runtime inspection engine is configured to analyze a natural language prompt in the request to determine whether the request corresponds to a permitted scope associated with an application generating the request,
wherein the runtime inspection engine is configured to analyze an answer in the response and determine whether the response corresponds to the permitted scope; and
a discovery engine configured to identify ML assets and applications implementing ML models, wherein the discovery engine is further configured to detect runtime usage of a workload that uses a second ML model that is unsanctioned.

2. The system of claim 1, wherein the runtime inspection engine includes a first pipeline configured to inspect the request or the response and approve benign traffic based on a plurality of guardrails,
wherein each guardrail is configured to classify whether a prompt in the request or an answer in the response corresponds to unsafe activity.

3. The system of claim 2, wherein the runtime inspection engine includes a second pipeline configured to inspect the request or the response based on identification of unsafe activity and identify content in the request or the response that corresponds to the unsafe activity.

4. The system of claim 1, wherein the system comprises a validation engine configured to:
execute a plurality of tests against an application or an ML model, wherein the plurality of tests are configured to invoke a response deemed insecure or improper; and
determine vulnerabilities associated with the application or the ML model based on responses associated with the plurality of tests.

5. A system for inspecting machine learning (ML) based payloads, comprising:
a runtime inspection engine configured to determine whether to allow a request or response to or from a first machine learning model based on an inspection of a payload of the request or the response;
a discovery engine configured to identify runtime usage of a workload that uses a second ML model, wherein the discovery engine detects the workload based on inspection of traffic and logs; and
a training inspection engine configured to inspect data provided to an ML training service during training of a third ML model and determine whether the data includes sensitive information or unsafe content.

6. The system of claim 5, wherein the runtime inspection engine is connected to at least one of:
a multicloud defense system deployed across a plurality of cloud systems for inspecting cloud-based traffic;
a secure client forming a virtual private network; and
a firewall associated with a private network.

7. The system of claim 5, wherein the inspection engine includes a first pipeline configured to inspect the request or the response and approve benign traffic based on a plurality of guardrails,
wherein each guardrail is configured to classify whether a prompt in the request or an answer in the response corresponds to unsafe activity.

8. The system of claim 7, wherein the inspection engine includes a second pipeline configured to inspect the request or the response based on identification of unsafe activity and identify content in the request or the response that corresponds to the unsafe activity.

9. The system of claim 5, further comprising a semantic cache for identifying usage patterns and application patterns.

10. The system of claim 5, further comprising an unsanctioned application engine configured to identify usage of an application using an unsanctioned machine learning model.

11. The system of claim 5, wherein the runtime inspection engine is configured to analyze a natural language prompt in the request to determine whether the request corresponds to a permitted scope associated with an application generating the request.

12. The system of claim 5, wherein the runtime inspection engine is configured to analyze an answer in the response and determine whether the response corresponds to a permitted scope.

13. The system of claim 5, wherein the runtime inspection engine is configured to:
inspect the request or the response for data leakage or data poisoning.

14. The system of claim 5, wherein the system comprises a validation engine configured to:
execute a plurality of tests against an application or an ML model, wherein the plurality of tests are configured to invoke a response deemed insecure or improper; and
determine vulnerabilities associated with the application or the ML model based on responses associated with the plurality of tests.

15. The system of claim 5, wherein the runtime inspection engine comprises a proxy mode for proxying requests and responses and an inspection mode for inspecting and authorizing API requests.

16. The system of claim 5, further comprising a log inspection engine configured to access third-party logs and logs associated with the system to identify usage of ML models.

17. A method comprising:
receiving, by a defense controller for machine learning (ML) or artificial intelligence (AI) based content, a prompt for an ML model including a natural language task to perform;
determining whether the prompt is authorized to be provided to the ML model based on the natural language task;
providing authorization in response to the prompt based on whether the prompt is authorized;
based on providing the prompt to the ML model, receiving an answer from the ML model, wherein the answer comprises at least a portion of natural language content; and
determining whether the answer is authorized for a requesting device based on content within the answer.

18. The method of claim 17, wherein the prompt is provided to the defense controller by at least one of a gateway of a multicloud defense system, a secure access client for accessing a private network, or a container in a distributed application.

19. The method of claim 17, wherein the defense controller is configured to determine whether the answer is authorized based on the prompt based and content within the answer.

20. The method of claim 17, further comprising:
identifying ML models and applications employing ML models accessible to clients within a private network; and
generating signatures associated with the ML models and prompts that are denied based on testing of the ML models,
wherein the authorization for the prompt or the answer is based on a comparison to the signatures.
